(19) United States
(12) Patent Application Publication
(10) Pub. No.: US 2026/0250501 A1
(43) Pub. Date: Aug. 27, 2026

(54) NATURAL MINERAL CRYSTAL-BASED MATTRESS MATERIAL AND PREPARATION METHOD THEREOF

(71) Applicant: ZHENGQI NEW MATERIALS TECHNOLOGY(CHANGZHOU) CO., LTD., Changzhou (CN)

(72) Inventors: LEI GUO, Changzhou (CN); BOWEN GUO, Changzhou (CN)

(73) Assignee: ZHENGQI NEW MATERIALS TECHNOLOGY(CHANGZHOU) CO., LTD., Changzhou (CN)

(21) Appl. No.: 19/653,078

(22) Filed: Apr. 20, 2026

Related U.S. Application Data
(63) Continuation of application No. PCT/CN2025/116764, filed on Aug. 25, 2025.

(30) Foreign Application Priority Data
Jun. 25, 2024 (CN) 2024108257898

(51) Int. Cl. C08L 33/26; A47C 27/14

(52) U.S. Cl. CPC C08L 33/26; A47C 27/14; C08L 2205/03; C08L 2312/06

(57) ABSTRACT

Provided are a natural mineral crystal-based mattress material and a preparation method thereof, which belong to the technical field of crystal materials. The method includes: preparing a porous photocatalytic crystal material through a sol-gel reaction, surface depositing magnetic ferroferric oxide on a surface of the material, modifying the material with a silane coupling agent, attaching copper oxide, manganese oxide and rare earth oxide to the material, calcining, adding the material into a chitosan-gelatin hydrogel, adding acrylamide, an initiator and a crosslinking agent, heating the mixture, carrying out reaction under stirring, and performing photocuring to prepare the natural mineral crystal-based mattress material. The natural mineral crystal-based mattress material prepared by this disclosure has low cost, can regulate sleep body temperature and humidity, has excellent comfort, good antibacterial, insect-resistant and anti-mite properties, and outstanding durability.

### CROSS-REFERENCE TO RELATED APPLICATIONS

The application claims priority to Chinese patent application No. 2024108257898, filed on Jun. 25, 2024, the entire contents of which are incorporated herein by reference.

### TECHNICAL FIELD

This disclosure relates to the technical field of crystal materials, and in particular, to a natural mineral crystal-based mattress material and a preparation method thereof.

### BACKGROUND

With the continuous improvement of living standards, people are paying growing attention to hygienic, safe and health-beneficial products. More and more people are living in a state of sub-health, as they feel stressed from the accelerated pace of modern life. The problem is, this same stress and jam-packed work-life schedule leave people with barely any free time to take care of and nurture their bodies. That is why products that support physical health without taking up people's downtime are gaining more and more attention, and mattresses that boost people's health while they sleep have naturally become the number one choice.

Natural crystal is a quartz crystal mineral, its main chemical component is silicon dioxide with the chemical formula of SiO₂, and it is also known as water essence, water jasper or water jade. Well-developed single crystals of natural crystal are hexagonal pyramids, so natural crystal usually exists as a massive or granular aggregate. Natural crystal can affect human health by generating electromagnetic fields, regulating the human body's energy field and other means, which is the so-called “mineral therapy”. In addition, natural crystal can collect negative ions from the outside and release them into the surrounding environment, thereby improving indoor air quality and relieving symptoms such as headache and insomnia.

However, directly adding natural crystal into a mattress cannot achieve a desirable health regulation effect, so it is necessary to modify the natural crystal.

### SUMMARY

An objective of this disclosure is to provide a natural mineral crystal-based mattress material and a preparation method thereof. The mattress material has low cost, can regulate sleep body temperature and humidity, has excellent comfort, good antibacterial, insect-resistant and anti-mite properties, and outstanding durability. It can emit far infrared waves, generate a magnetic field and negative ions to improve human health and purify ambient air, and is highly favored by consumers.

The technical solution of this disclosure is realized as follows:

This disclosure provides a preparation method of a natural mineral crystal-based mattress material. The method includes: preparing a porous photocatalytic crystal material through a sol-gel reaction, surface depositing magnetic ferroferric oxide on a surface of the material, modifying the material with a silane coupling agent, attaching copper oxide, manganese oxide and rare earth oxide to the material, calcining, adding the material into a chitosan-gelatin hydrogel, adding acrylamide, an initiator and a crosslinking agent, heating the mixture, carrying out reaction under stirring, and performing photocuring to prepare the natural mineral crystal-based mattress material.

As a further improvement of this disclosure, the method includes the following steps:
S1. Preparation of porous photocatalytic crystal material: ball-milling and sieving the natural mineral crystal, adding the sieved ball-milled natural mineral crystal into ethanol, adding alkyl orthosilicate, tetrabutyl titanate, a pore-forming agent and thiourea, stirring to mix evenly, dropwise adding an aqueous ammonia solution, carrying out reaction under stirring, then centrifuging, washing, ball milling and calcining to prepare a porous photocatalytic crystal material;
S2. Deposition of magnetic particles: adding the porous photocatalytic crystal material prepared in step S1 into water, adding ferric chloride and ferrous chloride, stirring to mix evenly, dropwise adding aqueous ammonia, carrying out reaction under stirring, aging, then filtering, washing and drying to prepare a magnetic porous photocatalytic crystal material;
S3. Attachment of ceramic powder: mixing the magnetic porous photocatalytic crystal material prepared in step S2, copper oxide powder, manganese oxide powder and rare earth oxide evenly, calcining, ball milling and sieving to prepare ceramic magnetic crystal powder;
S4. Preparation of modified powder: adding the ceramic magnetic crystal powder prepared in step S3 into ethanol, adding a composite silane coupling agent, heating the mixture, carrying out reaction under stirring, then filtering, washing and drying to prepare modified powder; and
S5. Preparation of natural mineral crystal-based mattress material: dissolving carboxymethyl chitosan in water, adding gelatin and the modified powder prepared in step S4, stirring to mix evenly, adding acrylamide, stirring to mix evenly, adding an initiator and a crosslinking agent, under an inert gas atmosphere, heating the mixture, carrying out reaction under stirring, pouring the reaction product into a mold, and performing UV photocuring to prepare the natural mineral crystal-based mattress material.

As a further improvement of this disclosure, in step S1, the sieve for sieving has a mesh number of 150-200 meshes, a mass ratio of the natural mineral crystal, alkyl orthosilicate, tetrabutyl titanate, a pore-forming agent, thiourea to aqueous ammonia is 15-20:7-10:4-7:0.5-1:0.2-0.3:12-15, concentration of the aqueous ammonia is 10-15 wt %, the reaction is carried out under stirring for 1-3 h, the ball milling is performed for 1-2 h, the calcination is performed at 550-650° C. for 1-3 h, and the pore-forming agent is at least one selected from a group consisting of cetyltrimethyl ammonium chloride, cetyltrimethyl ammonium sodium chloride, cetyl dimethyl benzyl ammonium chloride and cetyl dimethyl benzyl ammonium sodium chloride.

As a further improvement of this disclosure, in step S2, a mass ratio of the porous photocatalytic crystal material, ferric chloride, ferrous chloride to aqueous ammonia is 30-50:6.4-6.5:2.4-2.6:4-6, the concentration of the aqueous ammonia is 25-30 wt %, the carrying out reaction under stirring is performed at 65-75° C. for 3-5 h, and the aging time is 1-2 h.

As a further improvement of this disclosure, in step S3, a mass ratio of the magnetic porous photocatalytic crystal material, copper oxide powder, manganese oxide powder to rare earth oxide is 50:3-5:2-4:1-2, the calcination is performed at 1200-1300° C. for 30-40 min, the ball milling is performed for 1-2 h, and the rare earth oxide includes yttrium oxide and lanthanum oxide in a mass ratio of 2-4:3-5.

As a further improvement of this disclosure, in step S4, a mass ratio of the ceramic magnetic crystal powder to the composite silane coupling agent is 100:15-17, the composite silane coupling agent is at least one selected from a group consisting of KH550, KH560, KH570, A151, A171, KH580, KH590, KH602 and KH792, preferably a mixture of KH570 and KH560 in a mass ratio of 7-10:4-7, and the heating and carrying out reaction under stirring are performed at 40-50° C. for 1-3 h.

As a further improvement of this disclosure, in step S5, a mass ratio of carboxymethyl chitosan, gelatin, modified powder, acrylamide, an initiator to crosslinking agent is 12-15:8-10:10-12:13-18:0.1-0.2:1-2, the initiator is at least one selected from a group consisting of sodium persulfate, potassium persulfate and ammonium persulfate, the crosslinking agent is N,N′-methylene bisacrylamide, the heating and carrying out reaction under stirring are performed at 50-60° C. for 3-5 h, and the curing time is 1-2 h.

As a further improvement of this disclosure, the method specifically includes the following steps:
S1. Preparation of porous photocatalytic crystal material: ball-milling 15-20 parts by weight of natural mineral crystal, sieving the ball-milled natural mineral crystal through a 150-200 mesh sieve, adding the sieved ball-milled natural mineral crystal into ethanol, adding 7-10 parts by weight of alkyl orthosilicate, 4-7 parts by weight of tetrabutyl titanate, 0.5-1 part by weight of a pore-forming agent and 0.2-0.3 part by weight of thiourea, stirring to mix evenly, dropwise adding 12-15 parts by weight of 10-15 wt % aqueous ammonia solution, carrying out reaction under stirring for 1-3 h, then centrifuging, washing, ball milling for 1-2 h, and calcining at 550-650° C. for 1-3 h to prepare the porous photocatalytic crystal material;
S2. Deposition of magnetic particles: adding 30-50 parts by weight of the porous photocatalytic crystal material prepared in step S1 into 200 parts by weight of water, adding 6.4-6.5 parts by weight of ferric chloride and 2.4-2.6 parts by weight of ferrous chloride, stirring to mix evenly, dropwise adding 4-6 parts by weight of 25-30 wt % aqueous ammonia, carrying out reaction under stirring at 65-75° C. for 3-5 h, aging for 1-2 h, then filtering, washing and drying to prepare a magnetic porous photocatalytic crystal material;
S3. Attachment of ceramic powder: mixing 50 parts by weight of the magnetic porous photocatalytic crystal material prepared in step S2, 3-5 parts by weight of copper oxide powder, 2-4 parts by weight of manganese oxide powder and 1-2 parts by weight of rare earth oxide evenly, calcining at 1200-1300° C. for 30-40 min, ball milling for 1-2 h, and sieving to prepare ceramic magnetic crystal powder; where
the rare earth oxide includes yttrium oxide and lanthanum oxide in a mass ratio of 2-4:3-5;
S4. Preparation of modified powder: adding 100 parts by weight of the ceramic magnetic crystal powder prepared in step S3 into 500 parts by weight of ethanol, adding 15-17 parts by weight of a composite silane coupling agent, heating the mixture to 40-50° C., carrying out reaction under stirring for 1-3 h, then filtering, washing and drying to prepare the modified powder; where
the composite silane coupling agent is a mixture of KH570 and KH560 in a mass ratio of 7-10:4-7; and
S5. Preparation of natural mineral crystal-based mattress material: dissolving 12-15 parts by weight of carboxymethyl chitosan in 500 parts by weight of water, adding 8-10 parts by weight of gelatin and 10-12 parts by weight of the modified powder prepared in step S4, stirring to mix evenly, adding 13-18 parts by weight of acrylamide, stirring to mix evenly, adding 0.1-0.2 part by weight of an initiator and 1-2 parts by weight of a crosslinking agent N,N′-methylene bisacrylamide, under an inert gas atmosphere, heating the mixture to 50-60° C., and carrying out reaction under stirring for 3-5 h, pouring the reaction product into a mold, and performing UV photocuring for 1-2 h to prepare the natural mineral crystal-based mattress material.

This disclosure further claims protection of a natural mineral crystal-based mattress material prepared by the above preparation method.

This disclosure further claims protection for use of the above natural mineral crystal-based mattress material in preparing mattresses.

This disclosure has the following beneficial effects:
this disclosure takes natural mineral crystal as the core, coats a layer of TiO₂/SiO₂ on the surface of the crystal through a sol-gel reaction, and meanwhile introduces thiourea to dope S/C into the prepared TiO₂, which modifies the electron transition energy level and enables TiO₂ to realize photocatalysis with visible light, thereby improving the antibacterial and anti-mite properties of the mattress material, as well as its capabilities of air purification and adsorption of harmful gases in the air, and endowing the material with safety and environmental protection performance. Natural mineral crystal can affect human health by generating electromagnetic fields, regulating the human body's energy field and other means, which is the so-called “mineral therapy”. In addition, the natural mineral crystal can collect negative ions from the outside and release them into the surrounding environment, thereby improving indoor air quality and relieving symptoms such as headache and insomnia. Meanwhile, the prepared porous photocatalytic crystal material has a large specific surface area and contains numerous tiny pores, which can not only regulate indoor humidity, but also absorb moisture (or sweat) released by the human body during sleep to keep the body dry, thereby improving sleep quality.

Magnetic particles and ceramic powder are surface deposited, among which transition metal oxides (magnetic ferroferric oxide, copper oxide and manganese oxide) and rare earth oxides (yttrium oxide and lanthanum oxide) have a synergistic effect, and have the characteristics of low raw material cost and stable performance. The magnetic ferroferric oxide can generate a magnetic field, and the composite powder can emit far infrared waves at the same time. The far infrared waves can penetrate the skin, improve blood circulation, enhance metabolic function, reduce nerve excitability, relieve mild pain, improve pain caused by diseases such as arthritis and muscle spasm, activate the human immune system, enhance immunity, reduce the incidence of infectious diseases, relieve local inflammation caused by infection, and also have the functions of promoting cell regeneration, accelerating wound healing, enhancing metabolic capacity, promoting vasodilation and the like.

This disclosure modifies the prepared ceramic magnetic crystal powder with KH560 and KH570, so that the surface of the powder carries double bonds and epoxy groups. The double bonds can be polymerized with acrylamide simultaneously, and the epoxy groups can react with amino groups of chitosan, thereby improving the dispersibility of the modified powder in the gel, enabling the modified powder to be evenly dispersed in the gel, and playing a role in promoting crosslinking and improving mechanical properties.

The mattress material of this disclosure is mainly based on gel material. The chitosan-gelatin-polyacrylamide hydrogel adopted in this disclosure has excellent mechanical strength and curing performance, as well as good flexibility, which makes the mattress soft and comfortable, and has excellent antibacterial, insect-resistant and anti-mite properties, as well as good durability and high moisture content. During sleep, the human body temperature will rise due to blood circulation, which affects sleep comfort. In this disclosure, the gel molecules in the polymer gel can effectively absorb the heat generated by the human body and discharge it out of the body, then diffuse the heat to the entire mattress through conductivity, and keep the cycle continuously, which not only achieves the effect of cooling the human body for comfortable sleep, but also realizes the cooling effect in summer. The heat dissipation process is slow and will not cause discomfort to the human body. A waterproof barrier film will be arranged at the contact position inside the fabric to prevent volatilization of moisture in the gel, and meanwhile make it difficult for the gel molecules to move, which improves the comfort and application effect.

The natural mineral crystal-based mattress material prepared by this disclosure has low cost, can regulate sleep body temperature and humidity, has excellent comfort, good antibacterial, insect-resistant and anti-mite properties, and outstanding durability. It can emit far infrared waves, generate a magnetic field and negative ions to improve human health and purify ambient air, and is highly favored by consumers.

### DETAILED DESCRIPTION OF THE EMBODIMENTS

The technical solution in the embodiments of this disclosure will be clearly and completely described below. Apparently, the described embodiments are only some rather than all of the embodiments of this disclosure. Based on the embodiments of this disclosure, all other embodiments obtained by a person skilled in the art without creative work shall fall within the protection scope of this disclosure.

The natural mineral crystal is a mixed ore containing natural crystal and rare earth concentrate in a mass ratio of 10:5. The natural crystal is purchased from Lianyungang Haisheng Quartz Technology Co., Ltd., and the rare earth concentrate is purchased from China Northern Rare Earth (Group) High-Tech Co., Ltd.

### Example 1

This example provides a natural mineral crystal-based mattress material, which specifically includes the following steps:
S1. Preparation of porous photocatalytic crystal material: 15 g of natural mineral crystal was ball-milled, the ball milled natural mineral crystal was sieved through a 150-mesh sieve, the sieved ball milled natural mineral crystal was added into 200 g of ethanol, 7 g of methyl orthosilicate, 4 g of tetrabutyl titanate, 0.5 g of cetyltrimethyl ammonium chloride and 0.2 g of thiourea were added, the mixture was stirred to mix for 20 min, 12 g of 10 wt % aqueous ammonia solution was dropwise added, and was carried out reaction under stirring for 1 h, then the product was centrifuged, washed, ball-milled for 1 h, and calcined at 550° C. for 1 h to prepare the porous photocatalytic crystal material;
S2. Deposition of magnetic particles: 30 g of the porous photocatalytic crystal material prepared in step S1 were added into 200 g of water, 6.4 g of ferric chloride and 2.4 g of ferrous chloride were added, the mixture was stirred to mix for 15 min, 4 g of 25 wt % aqueous ammonia was dropwise added, and was carried out reaction under stirring at 65° C. for 3 h, the mixture was aged for 1 h, then the product was filtered, washed and dried to prepare the magnetic porous photocatalytic crystal material;
S3. Attachment of ceramic powder: 50 g of the magnetic porous photocatalytic crystal material prepared in step S2, 3 g of copper oxide powder, 2 g of manganese oxide powder and 1 g of rare earth oxide were mixed for 15 min, the mixture was calcined at 1200° C. for 30 min, ball-milled for 1 h, and sieved to prepare the ceramic magnetic crystal powder; where
the rare earth oxide includes yttrium oxide and lanthanum oxide in a mass ratio of 2:3;
S4. Preparation of modified powder: 100 g of the ceramic magnetic crystal powder prepared in step S3 were added into 500 g of ethanol, 15 g of composite silane coupling agent were added, the mixture was heated to 40° C., and was carried out reaction under stirring for 1 h, then the product was filtered, washed and dried to prepare the modified powder; where
the composite silane coupling agent is a mixture of KH570 and KH560 in a mass ratio of 7:4;
S5. Preparation of natural mineral crystal-based mattress material: 12 g of carboxymethyl chitosan were dissolved in 500 g of water, 8 g of gelatin and 10 g of the modified powder prepared in step S4 were added, the mixture was stirred to mix for 15 min, 13 g of acrylamide were added, the mixture was stirred to mix for 10 min, 0.1 g of potassium persulfate and 1 g of a crosslinking agent N,N′-methylene bisacrylamide were added, under a nitrogen atmosphere, the mixture was heated to 50° C., and was carried out reaction under stirring for 3 h, the reaction product was poured into a mold, and subjected to UV photocuring for 1 h to prepare the natural mineral crystal-based mattress material.

### Example 2

This example provides a natural mineral crystal-based mattress material, which specifically includes the following steps:
S1. Preparation of porous photocatalytic crystal material: 20 g of natural mineral crystal was ball-milled and sieved through a 200-mesh sieve, then added into 200 g of ethanol, 10 g of ethyl orthosilicate, 7 g of tetrabutyl titanate, 1 g of cetyl dimethyl benzyl ammonium sodium chloride and 0.3 g of thiourea were added, the mixture was stirred to mix for 20 min, 15 g of 15 wt % aqueous ammonia solution was dropwise added, and was carried out reaction under stirring for 3 h, then the product was centrifuged, washed, ball-milled for 2 h, and calcined at 650° C. for 3 h to prepare the porous photocatalytic crystal material;
S2. Deposition of magnetic particles: 50 g of the porous photocatalytic crystal material prepared in step S1 were added into 200 g of water, 6.5 g of ferric chloride and 2.6 g of ferrous chloride were added, the mixture was stirred to mix for 15 min, 6 g of 30 wt % aqueous ammonia was dropwise added, and was carried out reaction under stirring at 75° C. for 5 h, the mixture was aged for 2 h, then the product was filtered, washed and dried to prepare the magnetic porous photocatalytic crystal material;
S3. Attachment of ceramic powder: 50 g of the magnetic porous photocatalytic crystal material prepared in step S2, 5 g of copper oxide powder, 4 g of manganese oxide powder and 2 g of rare earth oxide were mixed for 15 min, the mixture was calcined at 1300° C. for 40 min, ball-milled for 2 h, and sieved to prepare the ceramic magnetic crystal powder; where
the rare earth oxide includes yttrium oxide and lanthanum oxide in a mass ratio of 4:5;
S4. Preparation of modified powder: 100 g of the ceramic magnetic crystal powder prepared in step S3 were added into 500 g of ethanol, 17 g of composite silane coupling agent were added, the mixture was heated to 50° C., and was carried out reaction under stirring for 3 h, then the product was filtered, washed and dried to prepare the modified powder; where
the composite silane coupling agent is a mixture of KH570 and KH560 in a mass ratio of 10:7;
S5. Preparation of natural mineral crystal-based mattress material: 15 g of carboxymethyl chitosan were dissolved in 500 g of water, 10 g of gelatin and 12 g of the modified powder prepared in step S4 were added, the mixture was stirred to mix for 15 min, 18 g of acrylamide were added, the mixture was stirred to mix for 10 min, 0.2 g of potassium persulfate and 2 g of a crosslinking agent N,N′-methylene bisacrylamide were added, under a nitrogen atmosphere, the mixture was heated to 60° C., and was carried out reaction under stirring for 5 h, the reaction product was poured into a mold, and subjected to UV photocuring for 2 h to prepare the natural mineral crystal-based mattress material.

### Example 3

This example provides a natural mineral crystal-based mattress material, which specifically includes the following steps:
S1. Preparation of porous photocatalytic crystal material: 17 g of natural mineral crystal was ball-milled and sieved through a 200-mesh sieve, then added into 200 g of ethanol, 8.5 g of ethyl orthosilicate, 5.5 g of tetrabutyl titanate, 0.7 g of cetyltrimethyl ammonium sodium chloride and 0.25 g of thiourea were added, the mixture was stirred to mix for 20 min, 13.5 g of 12 wt % aqueous ammonia solution was dropwise added, and was carried out reaction under stirring for 2 h, then the product was centrifuged, washed, ball-milled for 1.5 h, and calcined at 600° C. for 2 h to prepare the porous photocatalytic crystal material;
S2. Deposition of magnetic particles: 40 g of the porous photocatalytic crystal material prepared in step S1 were added into 200 g of water, 6.45 g of ferric chloride and 2.5 g of ferrous chloride were added, the mixture was stirred to mix for 15 min, 5 g of 27 wt % aqueous ammonia was dropwise added, and was carried out reaction under stirring at 70° C. for 4 h, the mixture was aged for 1.5 h, then the product was filtered, washed and dried to prepare the magnetic porous photocatalytic crystal material;
S3. Attachment of ceramic powder: 50 g of the magnetic porous photocatalytic crystal material prepared in step S2, 4 g of copper oxide powder, 3 g of manganese oxide powder and 1.5 g of rare earth oxide were mixed for 15 min, the mixture was calcined at 1250° C. for 35 min, ball-milled for 1.5 h, and sieved to prepare the ceramic magnetic crystal powder; where
the rare earth oxide includes yttrium oxide and lanthanum oxide in a mass ratio of 3:4;
S4. Preparation of modified powder: 100 g of the ceramic magnetic crystal powder prepared in step S3 were added into 500 g of ethanol, 16 g of composite silane coupling agent were added, the mixture was heated to 45° C., and was carried out reaction under stirring for 2 h, then the product was filtered, washed and dried to prepare the modified powder; where
the composite silane coupling agent is a mixture of KH570 and KH560 in a mass ratio of 8:5;
S5. Preparation of natural mineral crystal-based mattress material: 13.5 g of carboxymethyl chitosan were dissolved in 500 g of water, 9 g of gelatin and 11 g of the modified powder prepared in step S4 were added, the mixture was stirred to mix for 15 min, 15 g of acrylamide were added, the mixture was stirred to mix for 10 min, 0.15 g of sodium persulfate and 1.5 g of a crosslinking agent N,N′-methylene bisacrylamide were added, under a nitrogen atmosphere, the mixture was heated to 55° C., and was carried out reaction under stirring for 4 h, the reaction product was poured into a mold, and subjected to UV photocuring for 1.5 h to prepare the natural mineral crystal-based mattress material.

### Example 4

Compared with Example 3, the only difference is that the composite silane coupling agent is replaced by single KH570.

### Example 5

Compared with Example 3, the only difference is that the composite silane coupling agent is replaced by single KH560.

### Example 6

Compared with Example 3, the only difference is that the rare earth oxide is single yttrium oxide.

### Example 7

Compared with Example 3, the only difference is that the rare earth oxide is single lanthanum oxide.

### Comparative Example 1

Compared with Example 3, the only difference is that no ethyl orthosilicate is added in step S1.

### Specifically:

S1. Preparation of porous photocatalytic crystal material: 17 g of natural mineral crystal was ball-milled and sieved through a 200-mesh sieve, then added into 200 g of ethanol, 14 g of tetrabutyl titanate, 0.7 g of cetyltrimethyl ammonium sodium chloride and 0.25 g of thiourea were added, the mixture was stirred to mix for 20 min, 13.5 g of 12 wt % aqueous ammonia solution was dropwise added, and was carried out reaction under stirring for 2 h, then the product was centrifuged, washed, ball-milled for 1.5 h, and calcined at 600° C. for 2 h to prepare the porous photocatalytic crystal material;

### Comparative Example 2

Compared with Example 3, the only difference is that no tetrabutyl titanate is added in step S1.

### Specifically:

S1. Preparation of porous crystal material: 17 g of natural mineral crystal was ball-milled, the ball milled natural mineral crystal was sieved through a 200-mesh sieve, the sieved ball milled natural mineral crystal was added into 200 g of ethanol, 14 g of ethyl orthosilicate, 0.7 g of cetyltrimethyl ammonium sodium chloride and 0.25 g of thiourea were added, the mixture was stirred to mix for 20 min, 13.5 g of 12 wt % aqueous ammonia solution was dropwise added, and was carried out reaction under stirring for 2 h, then the product was centrifuged, washed, ball-milled for 1.5 h, and calcined at 600° C. for 2 h to prepare the porous crystal material.

### Comparative Example 3

Compared with Example 3, the only difference is that no thiourea is added in step S1.

### Specifically:

S1. Preparation of porous photocatalytic crystal material: 17 g of natural mineral crystal was ball-milled and sieved through a 200-mesh sieve, then added into 200 g of ethanol, 8.5 g of ethyl orthosilicate, 5.5 g of tetrabutyl titanate, 0.7 g of cetyltrimethyl ammonium sodium chloride were added, the mixture was stirred to mix for 20 min, 13.5 g of 12 wt % aqueous ammonia solution was dropwise added, and was carried out reaction under stirring for 2 h, then the product was centrifuged, washed, ball-milled for 1.5 h, and calcined at 600° C. for 2 h to prepare the porous photocatalytic crystal material.

### Comparative Example 4

Compared with Example 3, the only difference is that step S2 is not performed.

### Specifically:

S1. Preparation of porous photocatalytic crystal material: 17 g of natural mineral crystal was ball-milled and sieved through a 200-mesh sieve, then added into 200 g of ethanol, 8.5 g of ethyl orthosilicate, 5.5 g of tetrabutyl titanate, 0.7 g of cetyltrimethyl ammonium sodium chloride and 0.25 g of thiourea were added, the mixture was stirred to mix for 20 min, 13.5 g of 12 wt % aqueous ammonia solution was dropwise added, and was carried out reaction under stirring for 2 h, then the product was centrifuged, washed, ball-milled for 1.5 h, and calcined at 600° C. for 2 h to prepare the porous photocatalytic crystal material;
S2. Attachment of ceramic powder: 50 g of the porous photocatalytic crystal material prepared in step S1, 4 g of copper oxide powder, 3 g of manganese oxide powder and 1.5 g of rare earth oxide were mixed for 15 min, the mixture was calcined at 1250° C. for 35 min, ball-milled for 1.5 h, and sieved to prepare the ceramic crystal powder; where
the rare earth oxide includes yttrium oxide and lanthanum oxide in a mass ratio of 3:4;
S3. Preparation of modified powder: 100 g of the ceramic crystal powder prepared in step S2 were added into 500 g of ethanol, 16 g of composite silane coupling agent were added, the mixture was heated to 45° C., and was carried out reaction under stirring for 2 h, then the product was filtered, washed and dried to prepare the modified powder; where
the composite silane coupling agent is a mixture of KH570 and KH560 in a mass ratio of 8:5;
S4. Preparation of natural mineral crystal-based mattress material: 13.5 g of carboxymethyl chitosan were dissolved in 500 g of water, 9 g of gelatin and 11 g of the modified powder prepared in step S3 were added, the mixture was stirred to mix for 15 min, 15 g of acrylamide were added, the mixture was stirred to mix for 10 min, 0.15 g of sodium persulfate and 1.5 g of a crosslinking agent N,N′-methylene bisacrylamide were added, under a nitrogen atmosphere, the mixture was heated to 55° C., and was carried out reaction under stirring for 4 h, the reaction product was poured into a mold, and subjected to UV photocuring for 1.5 h to prepare the natural mineral crystal-based mattress material.

### Comparative Example 5

Compared with Example 3, the only difference is that no rare earth oxide is added in step S3.

### Specifically:

S3. Attachment of ceramic powder: 50 g of the magnetic porous photocatalytic crystal material prepared in step S2, 4 g of copper oxide powder and 3 g of manganese oxide powder were mixed for 15 min, calcined at 1250° C. for 35 min, ball milled for 1.5 h, and sieved to prepare ceramic magnetic crystal powder.

### Comparative Example 6

Compared with Example 3, the only difference is that step S4 is not performed.

### Specifically:

S1. Preparation of porous photocatalytic crystal material: 17 g of natural mineral crystal was ball-milled and sieved through a 200-mesh sieve, then added into 200 g of ethanol, 8.5 g of ethyl orthosilicate, 5.5 g of tetrabutyl titanate, 0.7 g of cetyltrimethyl ammonium sodium chloride and 0.25 g of thiourea were added, the mixture was stirred to mix for 20 min, 13.5 g of 12 wt % aqueous ammonia solution was dropwise added, and was carried out reaction under stirring for 2 h, then the product was centrifuged, washed, ball-milled for 1.5 h, and calcined at 600° C. for 2 h to prepare the porous photocatalytic crystal material;
S2. Deposition of magnetic particles: 40 g of the porous photocatalytic crystal material prepared in step S1 were added into 200 g of water, 6.45 g of ferric chloride and 2.5 g of ferrous chloride were added, the mixture was stirred to mix for 15 min, 5 g of 27 wt % aqueous ammonia was dropwise added, and was carried out reaction under stirring at 70° C. for 4 h, the mixture was aged for 1.5 h, then the product was filtered, washed and dried to prepare the magnetic porous photocatalytic crystal material;
S3. Attachment of ceramic powder: 50 g of the magnetic porous photocatalytic crystal material prepared in step S2, 4 g of copper oxide powder, 3 g of manganese oxide powder and 1.5 g of rare earth oxide were mixed for 15 min, the mixture was calcined at 1250° C. for 35 min, ball-milled for 1.5 h, and sieved to prepare the ceramic magnetic crystal powder; where the rare earth oxide includes yttrium oxide and lanthanum oxide in a mass ratio of 3:4;
S4. Preparation of natural mineral crystal-based mattress material: 13.5 g of carboxymethyl chitosan was dissolved in 500 g of water; 9 g of gelatin and 11 g of the ceramic magnetic crystal powder prepared in step S3 were added, and the mixture was stirred to mix for 15 min; 15 g of acrylamide was added, and the mixture was stirred to mix for 10 min; 0.15 g of sodium persulfate and 1.5 g of a crosslinking agent N,N′-methylene bisacrylamide were added; under a nitrogen atmosphere, the mixture was heated to 55° C., and was carried out reaction under stirring for 4 h; the reaction product was poured into a mold, and subjected to UV photocuring for 1.5 h, and the natural mineral crystal-based mattress material was prepared.

### Comparative Example 7

Compared with Example 3, the only difference is that no carboxymethyl chitosan is added in step S5.

### Specifically:

S5. Preparation of natural mineral crystal-based mattress material: 22.5 g of gelatin was dissolved in 500 g of water, 11 g of the modified powder prepared in step S4 were added, the mixture was stirred to mix for 15 min, 15 g of acrylamide were added, the mixture was stirred to mix for 10 min, 0.15 g of sodium persulfate and 1.5 g of a crosslinking agent N,N′-methylene bisacrylamide were added, under a nitrogen atmosphere, the mixture was heated to 55° C., and was carried out reaction under stirring for 4 h, the reaction product was poured into a mold, and subjected to UV photocuring for 1.5 h to prepare the natural mineral crystal-based mattress material.

### Test Example 1

The infrared emissivity of the ceramic magnetic crystal powders prepared in step S3 of Examples 1-3, 6, 7 and Comparative Examples 1-5 of this disclosure in the dual bands of 3 μm-5 μm and 8 μm-14 μm at room temperature was measured by an IR-2 dual-band emissivity measuring instrument. The results are as shown in Table 1.

TABLE 1

| | Infrared Emissivity | Infrared Emissivity |
|---|---|---|
| Group | in 3 μm-5 μm Band | in 8 μm-14 μm Band |
| Example 1 | 0.67 | 0.92 |
| Example 2 | 0.69 | 0.90 |
| Example 3 | 0.70 | 0.93 |
| Example 6 | 0.61 | 0.82 |
| Example 7 | 0.59 | 0.84 |
| Comparative | 0.63 | 0.88 |
| Example 1 | | |
| Comparative | 0.55 | 0.80 |
| Example 2 | | |
| Comparative | 0.58 | 0.83 |
| Example 3 | | |
| Comparative | 0.52 | 0.75 |
| Example 4 | | |
| Comparative | 0.48 | 0.71 |
| Example 5 | | |

It can be seen from the table above that the ceramic magnetic crystal powders prepared in Examples 1-3 of this disclosure have high infrared emissivity in the dual bands of 3 μm-5 μm and 8 μm-14 μm.

### Test Example 2

The mechanical properties of the natural mineral crystal-based mattress materials prepared in Examples 1-7 and Comparative Examples 1-7 of this disclosure were tested, and the results are as shown in Table 2.

TABLE 2

| | | | |
|---|---|---|---|
| Example 1 | 275.2 | 94.2 | 189.4 |
| Example 2 | 274.9 | 93.5 | 190.2 |
| Example 3 | 277.1 | 95.7 | 192.7 |
| Example 4 | 235.9 | 82.8 | 165.6 |
| Example 5 | 238.2 | 83.3 | 166.1 |
| Example 6 | 259.5 | 91.0 | 180.2 |
| Example 7 | 260.4 | 90.4 | 179.3 |
| Comparative Example 1 | 249.2 | 81.9 | 160.4 |
| Comparative Example 2 | 252.4 | 82.2 | 161.2 |
| Comparative Example 3 | 272.4 | 91.5 | 183.3 |
| Comparative Example 4 | 270.1 | 90.3 | 181.0 |
| Comparative Example 5 | 254.9 | 89.2 | 176.5 |
| Comparative Example 6 | 210.4 | 71.2 | 154.3 |
| Comparative Example 7 | 224.9 | 74.3 | 159.2 |

It can be seen from the table above that the natural mineral crystal-based mattress materials prepared in Examples 1-3 of this disclosure have excellent mechanical properties.

### Test Example 3

The comprehensive performance of the natural mineral crystal-based mattress materials prepared in Examples 1-7 and Comparative Examples 1-7 of this disclosure was tested.

Air permeability test: conducted according to GB/T 5453-1997 Test of Textiles-Fabric Air Permeability. 10 specimens of 30 cm×30 cm were taken for each group, and the average value was calculated. The breathable area of the specimen was 20 cm², and the test pressure drop was 200 Pa.

Compression property test: conducted according to GB/T 24442.1-2009 Textiles-Determination of Compression Properties-Part 1: Constant Rate Compression Method. 10 specimens were taken for each group, the presser foot area was 100 mm², the light pressure was 0.5 kPa, and the heavy pressure was 30 kPa. The compression ratio (%) and compression resilience ratio (%) of each specimen were calculated.

$$Compression ratio ( \% ) = ( Light pressure thickness - Heavy pressure thickness ) / Light pressure thickness \times 100 \%$$

$$Compression resilience ratio ( \% ) = ( Recovery thickness - Heavy pressure thickness ) / ( Light pressure thickness - Heavy pressure thickness ) \times 100 \%$$

Abrasion resistance test: conducted according to GB/T 21196.3-2007 Textiles-Martindale Method for Determination of Abrasion Resistance of Fabrics-Part 3: Determination of Mass Loss. The load pressure was 5.82 N, the specimen diameter was 38 mm, the initial friction was 100 times, and data was recorded every 50 times thereafter until the specimen was worn out. The abrasion resistance index was calculated.

Abrasion resistance index (times/mg)=Total friction times/Mass loss of the specimen after total friction times

Moisture vapor transmission test: conducted according to GB/T 12704.1-2009 Textiles-Test Method for Moisture vapor transmission of Fabrics-Part 2: Evaporation Method. 34 mL of water was poured into a moisture vapor transmissible cup, which was placed in a test instrument for 1 h. The relative humidity of the test chamber was 50%, and the relative humidity inside the moisture vapor transmissible cup was 100%. The Moisture Vapor Transmission Rate of the specimen was tested and calculated.

The test results are listed in Table 3.

TABLE 3

| | | | | | Moisture |
|---|---|---|---|---|---|
| | | | | Abrasion | Vapor |
| | Air | Compression | Compression | resistance | Transmission |
| | Permeability | Ratio | Resilience | index | Rate |
| Group | (mm/s) | (%) | Ratio (%) | (Times/mg) | (g/(m² · h)) |
| Example 1 | 1733 | 19.2 | 94.2 | 4.211 | 87.8 |
| Example 2 | 1704 | 19.0 | 93.9 | 4.198 | 86.9 |
| Example 3 | 1772 | 19.4 | 94.5 | 4.224 | 88.5 |
| Example 4 | 1652 | 16.7 | 87.6 | 3.922 | 82.1 |
| Example 5 | 1643 | 16.9 | 86.9 | 3.905 | 81.7 |
| Example 6 | 1692 | 18.8 | 93.1 | 4.025 | 85.9 |
| Example 7 | 1687 | 18.6 | 93.3 | 4.002 | 86.2 |
| Comparative | 1682 | 17.5 | 91.4 | 3.725 | 84.2 |
| Example 1 | | | | | |
| Comparative | 1677 | 17.9 | 90.5 | 3.804 | 84.4 |
| Example 2 | | | | | |
| Comparative | 1692 | 18.8 | 92.2 | 4.189 | 86.5 |
| Example 3 | | | | | |
| Comparative | 1688 | 18.5 | 92.0 | 4.177 | 86.1 |
| Example 4 | | | | | |
| Comparative | 1604 | 18.2 | 92.9 | 3.989 | 85.1 |
| Example 5 | | | | | |
| Comparative | 1489 | 15.1 | 81.2 | 3.572 | 78.2 |
| Example 6 | | | | | |
| Comparative | 1504 | 15.9 | 82.4 | 3.682 | 72.3 |
| Example 7 | | | | | |

It can be seen from the table above that the natural mineral crystal-based mattress materials prepared in Examples 1-3 of this disclosure have excellent comprehensive performance.

The above are only preferred embodiments of this disclosure, and are not intended to limit this disclosure. Any modifications, equivalent substitutions, improvements and the like made within the spirit and principle of this disclosure shall fall within the protection scope of this disclosure.

What is claimed is:

1. A preparation method of a natural mineral crystal-based mattress material, comprising the following steps:
S1. preparation of porous photocatalytic crystal material: ball-milling and sieving the natural mineral crystal, adding the sieved ball-milled natural mineral crystal into ethanol, adding alkyl orthosilicate, tetrabutyl titanate, a pore-forming agent and thiourea, stirring to mix evenly, dropwise adding an aqueous ammonia solution, carrying out reaction under stirring, then centrifuging, washing, ball milling and calcining to prepare a porous photocatalytic crystal material;
the natural mineral crystal is a mixed ore containing natural crystal and rare earth concentrate in a mass ratio of 10:5;
S2. deposition of magnetic particles: adding the porous photocatalytic crystal material prepared in step S1 into water, adding ferric chloride and ferrous chloride, stirring to mix evenly, dropwise adding aqueous ammonia, carrying out reaction under stirring, aging, then filtering, washing and drying to prepare a magnetic porous photocatalytic crystal material;
S3. attachment of ceramic powder: mixing the magnetic porous photocatalytic crystal material prepared in step S2, copper oxide powder, manganese oxide powder and rare earth oxide evenly, calcining, ball milling and sieving to prepare ceramic magnetic crystal powder; wherein
the rare earth oxide includes yttrium oxide and lanthanum oxide in a mass ratio of 2-4:3-5;
S4. preparation of modified powder: adding the ceramic magnetic crystal powder prepared in step S3 into ethanol, adding a composite silane coupling agent, heating the mixture, carrying out reaction under stirring, then filtering, washing and drying to prepare modified powder; and
the composite silane coupling agent is a mixture of KH570 and KH560 in a mass ratio of 7-10:4-7; and
S5. preparation of natural mineral crystal-based mattress material: dissolving carboxymethyl chitosan in water, adding gelatin and the modified powder prepared in step S4, stirring to mix evenly, adding acrylamide, stirring to mix evenly, adding an initiator and a crosslinking agent, under an inert gas atmosphere, heating the mixture, carrying out reaction under stirring, pouring the reaction product into a mold, and performing UV photocuring to prepare the natural mineral crystal-based mattress material.

2. The preparation method according to claim 1, wherein in step S1, the sieve for sieving has a mesh number of 150-200 meshes, a mass ratio of the natural mineral crystal, alkyl orthosilicate, tetrabutyl titanate, a pore-forming agent, thiourea to aqueous ammonia is 15-20:7-10:4-7:0.5-1:0.2-0.3:12-15, concentration of the aqueous ammonia is 10-15 wt %, the reaction is carried out under stirring for 1-3 h, the ball milling is performed for 1-2 h, the calcination is performed at 550-650° C. for 1-3 h, and the pore-forming agent is at least one selected from a group consisting of cetyltrimethyl ammonium chloride, cetyltrimethyl ammonium sodium chloride, cetyl dimethyl benzyl ammonium chloride and cetyl dimethyl benzyl ammonium sodium chloride.

3. The preparation method according to claim 1, wherein in step S2, a mass ratio of the porous photocatalytic crystal material, ferric chloride, ferrous chloride to aqueous ammonia is 30-50:6.4-6.5:2.4-2.6:4-6, the concentration of the aqueous ammonia is 25-30 wt %, the carrying out reaction under stirring is performed at 65-75° C. for 3-5 h, and the aging time is 1-2 h.

4. The preparation method according to claim 1, wherein in step S3, a mass ratio of the magnetic porous photocatalytic crystal material, the copper oxide powder, the manganese oxide powder to the rare earth oxide is 50:3-5:2-4:1-2, the calcination is performed at 1200-1300° C. for 30-40 min, and the ball milling is performed for 1-2 h.

5. The preparation method according to claim 1, wherein in step S4, a mass ratio of the ceramic magnetic crystal powder to the composite silane coupling agent is 100:15-17, and the heating and carrying out reaction under stirring are performed at 40-50° C. for 1-3 h.

6. The preparation method according to claim 1, wherein in step S5, a mass ratio of carboxymethyl chitosan, gelatin, modified powder, acrylamide, an initiator to crosslinking agent is 12-15:8-10:10-12:13-18:0.1-0.2:1-2, the initiator is at least one selected from a group consisting of sodium persulfate, potassium persulfate and ammonium persulfate, the crosslinking agent is N,N′-methylene bisacrylamide, the heating and carrying out reaction under stirring are performed at 50-60° C. for 3-5 h, and the curing time is 1-2 h.

7. The preparation method according to claim 1, specifically comprising the following steps:
S1. preparation of porous photocatalytic crystal material: ball-milling 15-20 parts by weight of natural mineral crystal, sieving the ball-milled natural mineral crystal through a 150-200 mesh sieve, adding the sieved ball-milled natural mineral crystal into ethanol, adding 7-10 parts by weight of alkyl orthosilicate, 4-7 parts by weight of tetrabutyl titanate, 0.5-1 part by weight of a pore-forming agent and 0.2-0.3 part by weight of thiourea, stirring to mix evenly, dropwise adding 12-15 parts by weight of 10-15 wt % aqueous ammonia solution, carrying out reaction under stirring for 1-3 h, then centrifuging, washing, ball milling for 1-2 h, and calcining at 550-650° C. for 1-3 h to prepare the porous photocatalytic crystal material;
S2. deposition of magnetic particles: adding 30-50 parts by weight of the porous photocatalytic crystal material prepared in step S1 into 200 parts by weight of water, adding 6.4-6.5 parts by weight of ferric chloride and 2.4-2.6 parts by weight of ferrous chloride, stirring to mix evenly, dropwise adding 4-6 parts by weight of 25-30 wt % aqueous ammonia, carrying out reaction under stirring at 65-75° C. for 3-5 h, aging for 1-2 h, then filtering, washing and drying to prepare a magnetic porous photocatalytic crystal material;
S3. attachment of ceramic powder: mixing 50 parts by weight of the magnetic porous photocatalytic crystal material prepared in step S2, 3-5 parts by weight of copper oxide powder, 2-4 parts by weight of manganese oxide powder and 1-2 parts by weight of rare earth oxide evenly, calcining at 1200-1300° C. for 30-40 min, ball milling for 1-2 h, and sieving to prepare ceramic magnetic crystal powder; wherein
the rare earth oxide includes yttrium oxide and lanthanum oxide in a mass ratio of 2-4:3-5;
S4. preparation of modified powder: adding 100 parts by weight of the ceramic magnetic crystal powder prepared in step S3 into 500 parts by weight of ethanol, adding 15-17 parts by weight of a composite silane coupling agent, heating the mixture to 40-50° C., carrying out reaction under stirring for 1-3 h, then filtering, washing and drying to prepare the modified powder; where
the composite silane coupling agent is a mixture of KH570 and KH560 in a mass ratio of 7-10:4-7; and
S5. preparation of natural mineral crystal-based mattress material: dissolving 12-15 parts by weight of carboxymethyl chitosan in 500 parts by weight of water, adding 8-10 parts by weight of gelatin and 10-12 parts by weight of the modified powder prepared in step S4, stirring to mix evenly, adding 13-18 parts by weight of acrylamide, stirring to mix evenly, adding 0.1-0.2 part by weight of initiator and 1-2 parts by weight of crosslinking agent N,N′-methylene bisacrylamide, under an inert gas atmosphere, heating the mixture to 50-60° C., and carrying out reaction under stirring for 3-5 h, pouring the reaction product into a mold, and performing UV photocuring for 1-2 h to prepare the natural mineral crystal-based mattress material.

8. A natural mineral crystal-based mattress material prepared by the preparation method according to claim 1.

9. An application of the natural mineral crystal-based mattress material according to claim 8 in preparing mattresses.
